(19) United States
(12) Patent Application Publication
(10) Pub. No.: US 2023/0292407 A1
(43) Pub. Date: Sep. 14, 2023

(54) ELECTRIC HEATING DEVICE

(71) Applicant: MAHLE International GmbH, Stuttgart (DE)

(72) Inventors: Nicolas Edel, Soultz-Haut-Rhin (FR); Mathieu Hildenbrand, Colmar (FR); Gilles Magnier, Rougemont-le-Chateau (FR); Judie Salmon, Strasbourg (FR)

(21) Appl. No.: 18/119,256

(22) Filed: Mar. 8, 2023

(30) Foreign Application Priority Data
Mar. 9, 2022 (EP) 22161052.0

(51) Int. Cl. H05B 3/44; H05B 3/12; H05B 1/02

(52) U.S. Cl. CPC H05B 3/44; H05B 3/12; H05B 1/0236; H05B 2203/023; H05B 2203/02; H05B 2203/017

(57) ABSTRACT

An electric heating device may include a heating volume, at least two heating modules arranged in the heating volume, an electrically conductive control housing, a power electronics, and an electrically conductive conductor arrangement. The control housing may delimit a control volume and may have a bottom that delimits the heating volume. The conductor arrangement may include an intermediate part electrically connected to the bottom and to an electrically conductive outer shell of each of the heating modules. The heating modules may each extend into the control volume through an associated passage opening of the bottom. The outer shell of each heating module may extend through an associated arrangement opening of the intermediate part. The conductor arrangement may include a cover covering the intermediate part. A closure bend of the intermediate part may extend through a cover opening of the cover and engage with the cover to form a form closure.

### CROSS-REFERENCE TO RELATED APPLICATIONS

This application claims priority to European Patent Application No. EP 22161052.0, filed on Mar. 9, 2022, the contents of which is hereby incorporated by reference in its entirety.

### TECHNICAL FIELD

The present invention relates to an electrical heating device, in particular for a motor vehicle, which has at least two electrically operated heating modules spaced apart from one another and power electronics for supplying the heating modules. The invention further relates to a motor vehicle having such a heating device and to method for manufacturing such a heating device.

### BACKGROUND

An electric heating device can be used to heat a fluid. Such an electrical heating device usually has a volume through which the fluid to be heated flows, which is also referred to as the heating volume in the following. Two or more heating modules are usually arranged in the heating volume. The respective heating module has at least one electrical heating element, for example a PTC element. When electrically supplied, the heating element generates heat and thus heats the fluid flowing through the heating volume. Such heating modules generally have an electrically conductive outer shell that encloses the at least one heating element. For electrical supply, the heater further usually comprises power electronics. The power electronics are usually accommodated in a volume that is fluidically separate from the heating volume, which is also referred to as the control volume in the following. Usually, the power electronics is accommodated in a housing which delimits the control volume and the heating volume. Such heating devices are known, for example, from EP 2 685 784 A1 and FR 3 075 552 A1.

Such a heating device is further known from EP 3 493 650 A1. The housing for accommodating the power electronics, hereinafter also referred to as the control housing, has a first housing part which delimits the heating volume. In a bottom of the first housing part, an opening is provided for the respective heating module, through which the heating module is inserted into the control volume. Further, the respective opening is sealed to fluidically separate the control volume from the heating volume. A conductor element is arranged in the control volume, which electrically connects the outer shells of the heating modules to one another so that they are at the same electrical potential.

EP 3 772 867 A1 discloses a heating device which comprises a conductor element is arranged in the control volume, which electrically connects the outer shells of the heating modules to one another so that they are at the same electrical potential. The conductor element for the respective heating module comprises a corresponding opening wherein contact tongues of the conductor element rest against the outer shells. The contact tongues project from openings of the conductor element, through which the heating modules are led.

### SUMMARY

The present invention is concerned with the problem of providing improved or at least other embodiments for an electric heating device of the type mentioned above and for a motor vehicle with such a heating device, which address disadvantages of solutions in the prior art. The present invention is in particular concerned with the problem of providing improved or at least other embodiments for the electric heating device and the motor vehicle which are characterized by increased operational safety and/or reduced operational malfunction and/or simplified manufacture of the heating device.

This problem is solved according to the invention by the subject matter of the independent claim(s). Advantageous embodiments are the subject matter of the dependent claim(s).

The present invention is based on the general to provide a conductor arrangement in an electric heating device for electrically connecting outer shells of heating modules to a housing for the reception of power electronics, such that the outer shells and the housing are at the same electrical potential, wherein the conductor arrangement comprises a first part which electrically contacts the outer shells to the housing and a second part which covers the first part and is connected to the first part by means of at least one form closure. Therefore, the second part, also referred to as cover in the following, protects the first part, also referred to as intermediate part in the following. As a result, damages of the intermediate part as well as the electric connection of the intermediate part with the outer shells and the housing are prevented or at least reduced. Hence, the outer shells as well as the housing are connected to the same electrical potential, i.e. are equipotential, with increased stability. Therefore, the operational safety of the electric heating device is increased. In addition, the cover can be used to mechanically bias the intermediate part against the housing and/or the outer shells. Thus, the electric connection of the intermediate part with the housing and/or the outer shells is increased and stabilized. Therefore, the operational safety of the electric heating device in further increased. The increased and improved electric contact further leads to a reduced disturbance in the operation of the electric heating device. In addition, an examination of the electrical conditions of one of the equipotentially connected components, in particular of the housing, can thus detect undesirable electrical currents and/or leakages of the electric heating device in a simple and reliable manner. This results in improved operational reliability. Moreover, the intermediate part and the cover can be preassembled and, as a preassembled unit, be mounted on the outer shells and the housing. This results in a simplified manufacture of the electric heating device.

In accordance with the idea of the invention, the electrical heating device, also simply denoted heating device in the following, has a volume through which a flow path of a fluid leads, whereby the fluid is heated during operation. This volume is hereinafter also referred to as the heating volume. In the heating volume, the heating device has at least two heating modules which are spaced apart from one another in a direction also referred to as transverse direction hereinafter. In particular, the heating modules are arranged in the flow path. The respective heating module extends longitudinally in a direction that is also referred to hereinafter as the longitudinal direction. The respective heating module has at least one electrical heating element. The respective electrical heating element is such that it generates heat when electrically supplied. Thus, the fluid is heated by the heating modules during operation. The respective heating module has the electrically conductive outer shell. Advantageously, the outer shell is formed as a flat tube. The heating device further comprises the housing which is electrically conductive. The housing is hereinafter also referred to as the control housing. The housing delimits a volume. The volume delimited by the housing is also referred to as control volume hereinafter. In the control volume, the heating device has power electronics. With the power electronics, the heating modules, in particular the heating elements, are electrically supplied during operation. The housing has a bottom which delimits the heating volume. The bottom of the housing has an opening for the respective heating module. These openings of the bottom are hereinafter also referred to as passage openings. The respective heating module penetrates into the control volume in the longitudinal direction through the corresponding passage opening. The respective heating module is inserted into the control volume in particular in the longitudinal direction through the corresponding passage opening. In the control volume, the heating modules are electrically connected to the power electronics, so that the heating elements are electrically supplied with the power electronics during operation. The heating device further has the conductor arrangement which electrically connects the respective outer shell to the housing and the outer shells to each other. The conductor arrangement comprises the intermediate part which rests against the bottom and is electrically connected to the bottom and to the outer shells. The intermediate part, for each outer shell, comprises a corresponding opening, through which the corresponding outer shell is led in longitudinal direction. These opening are also referred to as arrangement openings in the following. The conductor arrangement, on the side of the intermediate part averted form the bottom, further comprises the cover which covers the intermediate part. The intermediate part comprises at least one bend which projects in the direction of the cover and is also referred to as closure bend in the following. The cover, for each closure bend, comprises a corresponding opening also referred to as cover opening in the following. Each closure bend is led through the corresponding cover opening and engages with the cover to form a form closure.

The cover is, as mentioned, arranged on the side of the intermediate part averted form the bottom. Thus, the intermediate part is arranged preferably entirely arranged between the bottom and the cover and covered by the cover.

The conductor arrangement is advantageously mechanically fixed, preferably fastened, to the bottom. In preferred embodiments, the intermediate part and the cover are fastened to the bottom. Advantageously, the conductor arrangement, in particular the intermediate part and the cover, are detachably fastened to the bottom. Advantageously, the mechanical connection also provides an electrical connection.

The respective outer shell preferably encloses the at least one heating element of the associated heating module.

The transverse direction preferably runs transverse to the longitudinal direction.

Each heating module has preferably a front face in longitudinal direction which is arranged in the control volume.

Preferably, each heating module comprises at least one electric plug projecting from the front face and electrically connected to the power electronics. Each electric plug is preferably electrically separated from the outer shells and thus from the housing.

Each outer shell might have two walls opposite in the transverse direction, which are also referred to hereinafter as outer walls. Each outer shell might have two walls opposite in a direction transverse to the longitudinal direction and transverse to the transverse direction which are also referred to as side walls in the following. The side walls of the outer shell might connect the outer walls to each other and vice versa.

The direction transverse to the longitudinal direction and transverse to the transverse direction is also referred to as vertical direction in the following.

The bottom of the housing, in preferred embodiments, delimits the heating volume. That is, the bottom preferably separates the heating volume from the control volume.

The control housing, in general, can be a one-part housing.

Preferably the control housing comprises an electrically conductive first housing part and an electrically conductive second housing part electrically connected to one another and delimiting the control volume. The housing parts are preferably detachably connected to each other. This simplifies the manufacture of the heating device and further allows access to the control volume if needed.

The first housing part might comprise the bottom. Thus the intermediate part is electrically and mechanically connected to the first housing part.

Preferably, the common potential corresponds to an electrical ground. For this purpose, at least one of the equipotentially connected components, i.e. the housing, in particular at least of the housing parts, the conductor arrangement or at least one of the outer shells is electrically connected to an electrical ground, for example the electrical ground of an associated application. Particularly preferably, only one of said components is electrically connected to the electrical ground. Advantageously, one of the housing parts is electrically connected to the electrical ground.

In the respective passage opening, a sealing arrangement fluidically sealing the control volume from the heating volume can be arranged. The sealing arrangement is preferably insulating. The sealing arrangement comprises at least one sealing body.

Conveniently, the conductor arrangement is separate from the sealing arrangement.

In preferred embodiments at least one closure bend, preferably each closure bend, is designed in the manner of a spring clip. For this, the closure bend preferably comprises a lower section on the side facing the bottom and an upper section connected to the lower section and running inclined to the lower section towards the bottom. The closure bend and thus the spring clip and the corresponding cover opening are further designed such that, when the cover and the intermediate part are moved toward each other, the closure bend is led through the cover opening and latches into the cover to form a form closure. This simplified the assembly of the intermediate part to the cover and thus the manufacture of the heating device. Furthermore, an increased stability of the mechanical connection of the intermediate part with the cover is achieved.

Preferably, the closure bend and the corresponding cover opening are designed such that, when the cover and the intermediate part are moved toward each other in longitudinal direction, the closure bend is led through the cover opening, in particular latches into the cover, to form a form closure. This simplifies the assembly of the intermediate part to the cover and thus the manufacture of the heating device.

Advantageously, the cover, on the side facing the intermediate part, comprises at least one projecting bump which presses the intermediate part towards the bottom. This leads to an increased and/or more stabilized mechanical and electric contact of the intermediate part with the bottom. Thus, the operational safety of the heating device in further increased.

Advantageously, the conductor arrangement is fastened to the bottom by means of at least one screw. This leads to a simplified manufacture of the heating device and a stable mechanical and electric connection of the conductor arrangement to the bottom.

Preferably, the intermediate part and the cover comprise corresponding openings for common screws. The openings are also referred to as fastening openings in the following. Thus at least one common screw fastens the intermediate part and the cover to the bottom. The result is a simplified manufacture of the heating device.

In preferred embodiments, a common screw is led through the corresponding fastening openings and screwed into the bottom, such that a screw head of the screw rests on the cover and presses the cover and the intermediate part towards the bottom. This results in an and/or more stabilized mechanical and electric contact of the intermediate part with the bottom. Thus, the operational safety of the heating device in further increased.

In advantageous embodiments, the bottom, for at least one of the at least one screws, comprises a corresponding collar which projects towards the intermediate part and in which the screw is arranged. The intermediate part comprises a corresponding opening for the collar, thorough which the corresponding collar is led. The opening is also referred to as collar opening in the following. The intermediate part further comprises a bend which projects towards the cover and comprises the fastening opening corresponding to the screw. The bend is also referred to as screw bend in the following. The screw bend rests on the side of the collar facing away from the bottom and thus facing the cover. As a result, the screw bend is clamped between the collar and the cover. This results in an increased and/or more stable electric contact of the intermediate part with the housing. Thus, the operational safety of the heating device in further increased.

Preferably, the bottom for each screw comprises such a corresponding collar.

Preferably, the intermediate part for each collar comprises such a corresponding collar opening and screw bend.

Advantageously, the screw bend is a result of the corresponding collar opening. That is, the collar opening is designed such that material of the intermediate part remains, wherein this remaining material is bent to form the screw bend.

Advantageously, at least one of the at least one collars, in particular each collar, comprises an internal thread in which the corresponding screw is screwed.

The intermediate part and the cover can be arranged in the heating volume and in particular outside the control volume.

In preferred embodiments, the intermediate part and the cover are arranged inside the control volume, further preferably outside the heating volume. This results in a simplified manufacture of the heating device. Moreover, flow resistance caused by the conductor arrangement for the fluid flowing to the heating volume is at least reduced.

In advantageous embodiments, the cover covers the front face of at least one heating module, preferably of each heating module, from which the at least one plug projects. The cover further, for each plug, comprises a corresponding opening, through which the corresponding plug is led. The openings are also referred to as plug openings in the following. Thus the protection of the intermediate part is improved. Moreover, the protection of the front face and hence the inner volume of the heating module is improved.

The electric contact of the intermediate part with the respective outer shell in preferably realized by a mechanical contact of the intermediate part with the respective outer shell. That is, the intermediate part mechanically and electrically contacts the respective outer shell. This leads to a simplified manufacture and a more stable electric connection.

In preferred embodiments, the intermediate part, for each outer shell, comprises at least one spring element which protrudes from the corresponding arrangement opening, rests on the corresponding outer shell and is mechanically loaded against the outer shell. Preferably, the intermediate part, for each outer shell, comprises at least two such corresponding spring elements. Thus, the heating modules can be easily and precisely led through the corresponding arrangement openings. Furthermore, the electric and mechanical contact between the intermediate part and the outer shells is improved and mechanically stabilized. Hence, the manufacture of the heating device is simplified and operational safety is increased.

Advantageously, the spring elements are a result of the corresponding arrangement opening. That is, the arrangement opening is designed such that material of the intermediate part is remains, wherein this remaining material is bent to form the spring elements.

The cover preferably, for each spring element, comprises a corresponding bump, wherein each bump presses the intermediate part towards the bottom, such that the corresponding spring element is mechanically pressed against the corresponding outer shell. This results in a more stable contact between the intermediate part and the outer shell. Thus the operational safety is increased.

In preferred embodiments, at least one of the spring elements, preferably each spring element, is coated with a friction-resistant and conductive material on its side facing the corresponding outer shell. This leads to a more stable contact between the intermediate part and the outer shells resulting in a more stable electric contact. Therefore, the operational safety is increased.

The friction-resistant and conductive coating can in general be of any material. Preferably, the friction-resistant and conductive material is silver. That is, at least one of the spring elements is preferably coated with silver on its side facing the corresponding outer shell to increase friction.

In general, the intermediate part and/or the cover can be multi-part.

Preferably, the intermediate part is a one-piece part and monolithic. This leads to a simplified and cost reduced manufacture of the heat device.

Preferably, the cover is a one-piece part and monolithic. Thus the manufacture of the heating device is simplified and cost reduced.

In preferred embodiments, the intermediate part is a sheet-metal part, particularly a one-piece and monolithic sheet-metal part. This leads to a simplified and cost reduced manufacture of the heat device. Also, the intermediate part functions as an electromagnetic shield. Thus, the operation of the heating device is more safe and/or reliable.

The cover can be a sheet-metal part, particularly a one-piece and monolithic sheet-metal part.

The cover can be molded part, in particular injection-molded part or die-casted.

The cover can be electrically conductive.

It is understood, that the method for manufacturing the heating device as such also lays within the scope of the present invention.

The heating device is thereby preferably manufactured by leading the heating modules through the bottom, preassembling the intermediate part on the cover, and arranging the preassembled unit of the cover and the intermediate part on the bottom and fastening them to the bottom, such that each outer shell is led through the corresponding arrangement opening, and such that the intermediate part is electrically connected to the outer shells and the bottom of the housing.

The heating device can be used in any application to heat a fluid.

The heating device is used in particular in a motor vehicle to heat a fluid, for example air.

Advantageously, the control housing is electrically connected to the electrical ground of the motor vehicle. Particularly preferably, the first housing part is electrically connected to the electrical ground of the motor vehicle. For this purpose, an electrical plug or plug socket is preferably provided.

It goes without saying that the motor vehicle with the heating device is also subject of the present invention.

Further important features and advantages of the invention are apparent from the dependent claims, from the drawings, and from the accompanying figure description based on the drawings.

It is understood that the above features and those to be explained hereinafter can be used not only in the combination indicated in each case, but also in other combinations or on their own, without leaving from the scope of the present invention.

Preferred embodiments of the invention are shown in the drawings and will be explained in more detail in the following description, wherein identical reference signs refer to identical or similar or functionally identical components.

### BRIEF DESCRIPTION OF THE DRAWINGS

The Figures show, in each case schematically

FIG. 1 shows an isometric view of an electric heating device with a housing,

FIG. 2 shows a highly simplified, schematic diagram of a motor vehicle with the heating device,

FIG. 3 shows an isometric view of a portion of the heating device toward a control volume,

FIG. 4 shows a section through the heating device with a top view on the control volume,

FIG. 5 shows an isometric view of a portion of the heating device toward a control volume,

FIG. 6 shows a section through the heating device in the area of an opening of the housing,

FIG. 7 shows another section through the heating device in the area of the control volume,

FIG. 8 shows an isometric view of a portion of the heating device toward the control during manufacture of the heating device,

FIG. 9 shows a section through a control housing of the heating device,

FIG. 10 shows an enlarged view of the area marked X in FIG. 9,

FIG. 11 shows an isometric view of a portion of the control housing in another exemplary embodiment,

FIG. 12 shows a top view of the heating device in a further exemplary embodiment.

### DETAILED DESCRIPTION

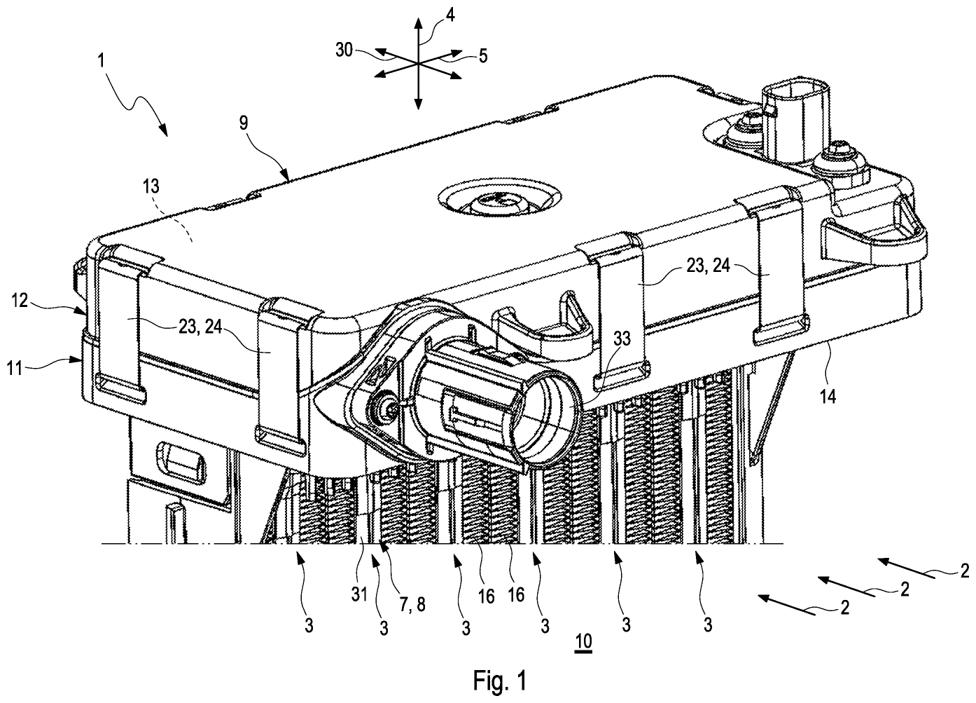

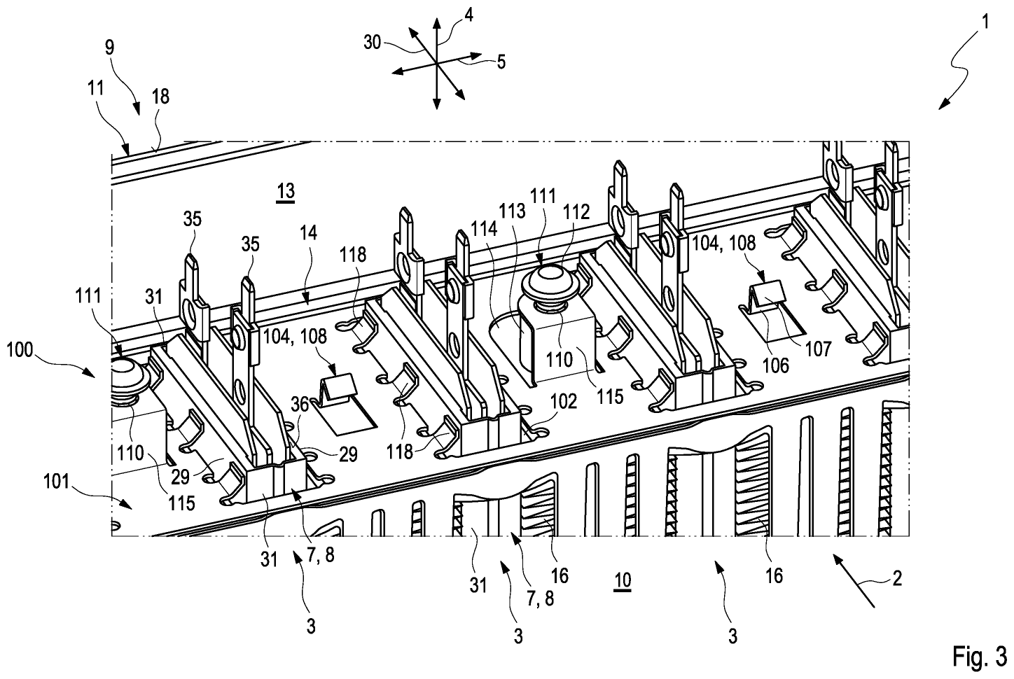

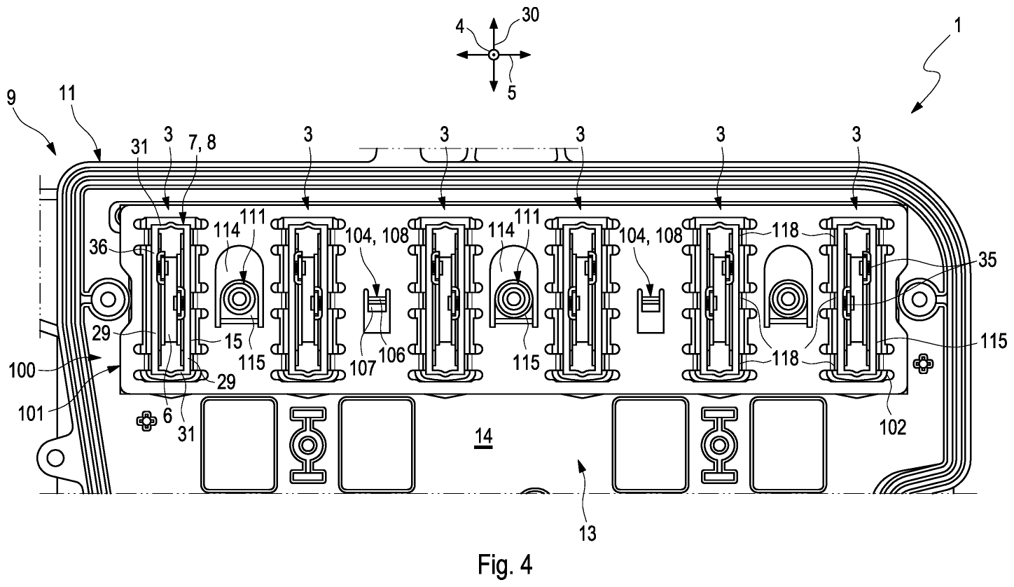

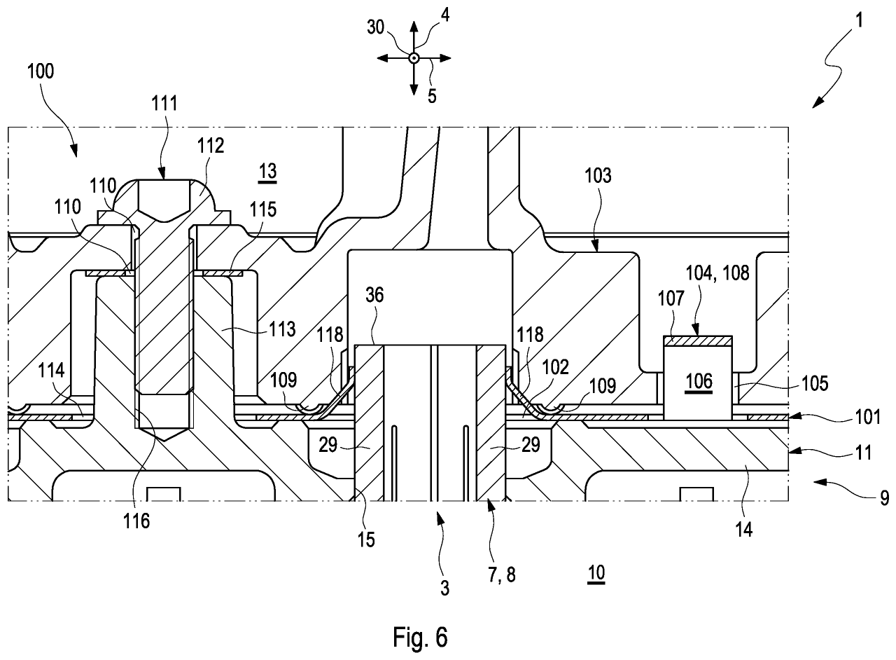

An electric heating device 1, as shown for example in FIGS. 1 to 12, is used for heating a fluid. For this purpose, a flow path 2 of the fluid (see FIG. 1) leads through the heating device 1. At least two heating modules 3 of the heating device 1 are arranged in the flow path 2. The respective heating module 3 extends longitudinally in a longitudinal direction 4. The heating modules 3 are spaced apart from one another in a transverse direction 5 extending transversely to the longitudinal direction 4. The respective heating module 3 has at least one heating element 6 indicated in FIG. 4. The heating element 6 is designed in such a way that it generates heat when electrically supplied during operation. As a result, the fluid is heated. The respective heating element 6 is designed, for example, as a PTC element, where PTC stands for “Positive Temperature Coefficient”. The respective heating module 3 further comprises an electrically conductive outer shell 7, which encloses the at least one heating element 6. In the exemplary embodiments shown, the respective outer shell 7 is formed as a flat tube 8. As can be seen, for example, from FIG. 1, the heating device 1 further comprises a housing 9, which is hereinafter referred to as the control housing 9. The control housing 9 is adjacent to a volume 10 through which the flow path 2 passes. The volume 10 is also referred to hereinafter as the heating volume 10. The control housing 9 in the shown exemplary embodiments has a first housing part 11 and a second housing part 12 electrically connected to each other. The first housing part 11 and the second housing part 12 delimit a volume 13 in the control housing 9 (see for example FIG. 3), which is also referred to hereinafter as control volume 13. Power electronics (not shown) are arranged in the control volume 13, with which the respective heating module 3, in particular the heating elements 6, are electrically supplied. The housing 9 and is electrically conductive. In the shown exemplary embodiments thus the housing parts 11, 12, are each electrically conductive. The housing 9 has a bottom 14 which delimits the heating volume 10 and thus separates it from the control volume 13. In the shown exemplary embodiments, the first housing part 11 comprises the bottom 14. In the bottom 14, a corresponding opening 15 is provided for each heating module 13 (see in particular FIG. 6). The respective opening 15 is also referred to hereinafter as the passage opening 15. The respective heating module 3 is inserted in longitudinal direction 4 through the associated passage opening 15 and thus enters the control volume 13. Within the control volume 13, the respective heating module 3 is further electrically connected to the power electronics (not shown) in order to electrically supply the heating elements 6. To this end, each heating module 3 comprises at least one electric plug 35 (see FIG. 3) arranged in the control volume 13 and connected to the power electronics. In the shown exemplary embodiments, each heating module 3 comprises two such plugs 35. In the shown exemplary embodiments, a sealing arrangement (not visible) is arranged in the respective passage opening 15 between the outer shell 7 and the passage opening 15 which fluidically seals the control volume 13 from the heating volumes 10. Preferably, the sealing arrangement further electrically isolates the outer shells 7 from the first housing part 11.

In the shown exemplary embodiments, each outer shell 7 has two opposing outer walls 29 in the transverse direction 5. In addition, the respective outer shell 7 has two opposing side walls 31 in a vertical direction 30 extending transversely to the longitudinal direction 4 and transversely to the transverse direction 5. The side walls 30 connect the outer walls 29 to each other and vice versa.

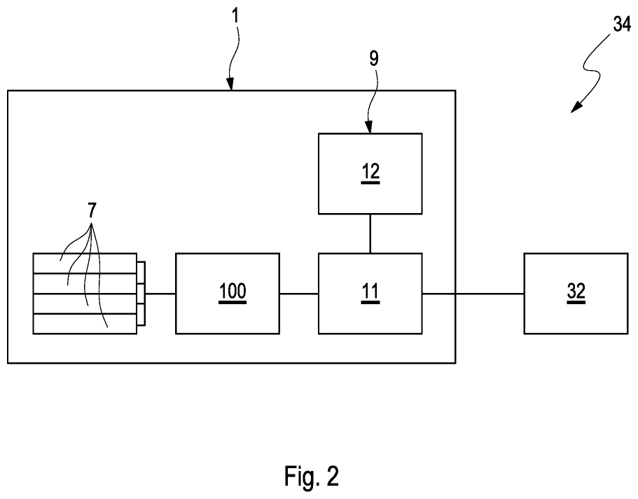

As can be seen in particular from FIGS. 2 to 8, the heating device 1 has a conductor arrangement 100. The conductor arrangement 100 is separate from the sealing arrangement. The conductor arrangement 100 electrically connects the respective outer shell 7 to the housing 9. In the shown exemplary embodiments, the conductor arrangement 100 electrically connects the respective outer shell 7 to the first housing part 11. Thus, the outer shells 7 are electrically connected to the first housing part 11 and to each other. In addition, the outer shells 7 are electrically connected to the second housing part 12. As a consequence, the outer shells 7 and the housing parts 11, 12 are connected to the same electrical potential. As can be seen from FIG. 2, the electrical potential is a ground 32. The heating device 1 thereby electrically connected to a corresponding ground 32. In the exemplary embodiment shown in FIG. 2, this is done by electrically connecting the first housing part 11 to the ground 32. For this purpose, a corresponding electrical plug socket 33 can be provided on the first housing part 11, as can be seen in FIG. 1. In the exemplary embodiment shown in FIG. 2, the heating device 1 is used in a motor vehicle 34, which is not otherwise shown. The first housing part 11 is electrically connected to the electrical ground 32 of the motor vehicle 34.

In the exemplary embodiments shown, the conductor arrangement 100 is arranged outside of the heating volume 10 and within the control volume 13. In the exemplary embodiments shown, the conductor arrangement 100 is electrically connected to the bottom 14 of the first housing portion 11.

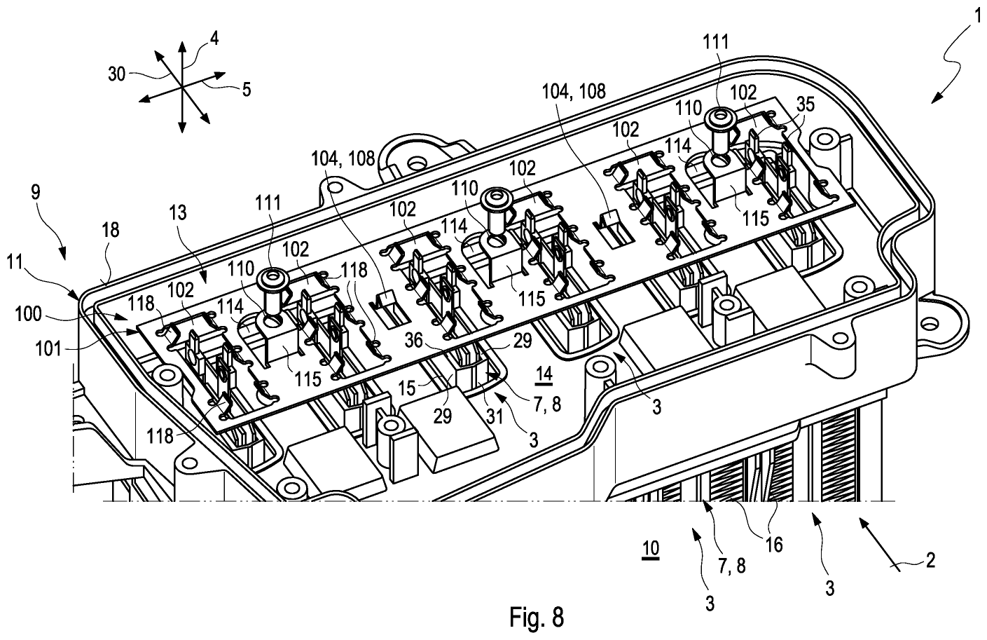

As shown in FIGS. 2 to 8, the conductor arrangement 100 comprises an electrically conductive intermediate part 101. The conductor arrangement 100 further, on the side of the intermediate part 101 averted form the bottom 14, comprises a cover 103 which covers the intermediate part 101. For the sake of comprehension, the cover 103 is not shown in FIGS. 2, 3 and 8 and the intermediate part 101 is shown distanced to the bottom 14 in FIG. 8. Furthermore, for the sake of comprehension, the second housing part 12 is not shown in FIGS. 3 to 8.

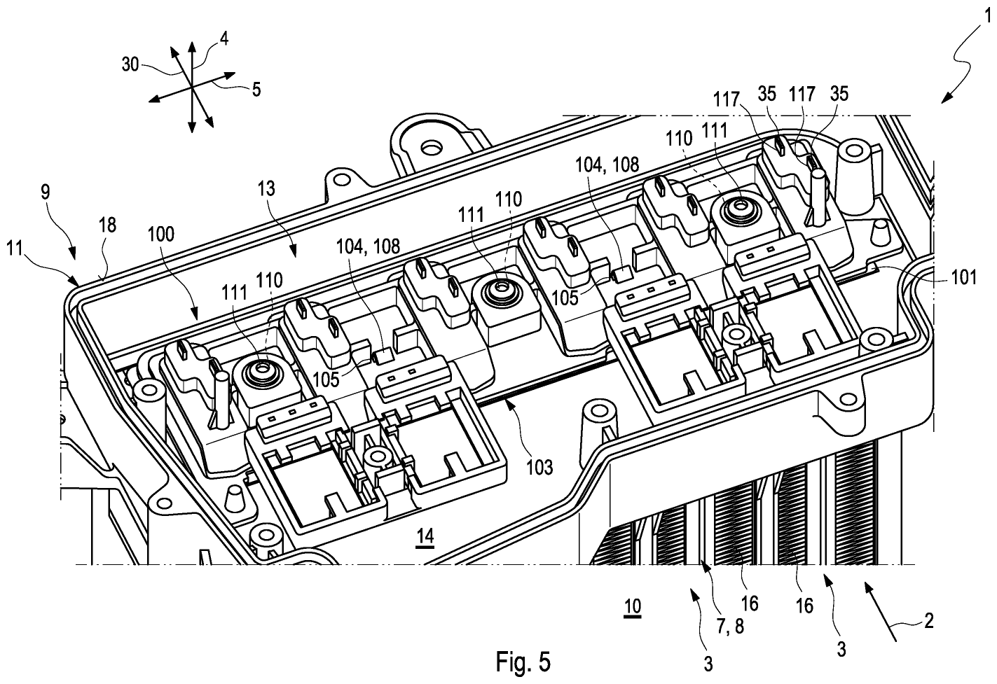

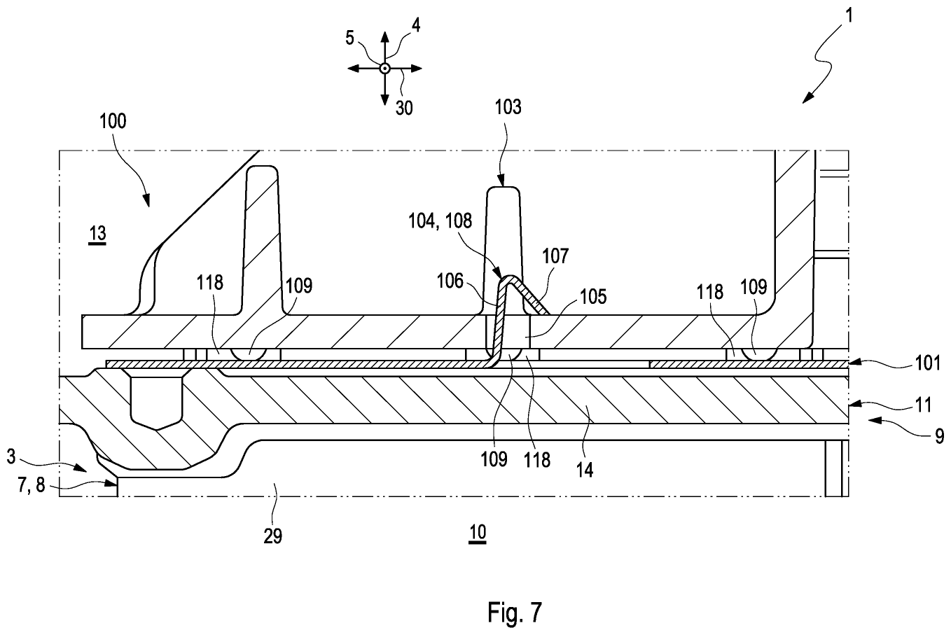

The intermediate part 101 rests against the bottom 14 and is electrically connected to the bottom 14 and to the outer shells 7, as in particular shown in FIGS. 3, 4 and 6. The intermediate part 101, for each outer shell 7 comprises a corresponding opening 102, through which the corresponding outer shell 7 is led in longitudinal direction 4 (see for instance FIGS. 3 and 4). The openings 102 are also referred to as arrangement opening 102 in the following. As in particular shown in FIGS. 3, 4 and 6, the intermediate part 101 comprises at least one bend 104 which projects in the direction of the cover 103. The bend 104 will also be referend to as closure bend 104 in the following. As shown in particular in FIGS. 5, 6 and 7, the cover 103 for each closure bend 104 comprises a corresponding opening 105. The opening 105 will also be referend to as closure cover opening 105 in the following. Each closure bend 104 is led through the corresponding cover opening 105 and engages with the cover 103 to form a form closure, as in particular shown in FIGS. 6 and 7. This allows the intermediate part 101 to be preassembled with the cover 103. Thus the intermediate part 101 together with the cover 103 can be easily and safely mounted in the housing 9. In the examples shown, the intermediate part 101, by way of example, comprises two closure bends 104 which are distanced to each other in transverse direction 5 (see FIG. 4). Hence, the cover 103 comprises two cover openings 105 distanced to each other in transverse direction 5 (see FIG. 5).

In the examples shown, each closure bend 104 is designed in the manner of a spring clip 108. For this, each closure bend 104 comprises a lower section 106 on the side facing the bottom 14 and an upper section 107 connected to the lower section 106 and running inclined to the lower section 106 towards the bottom 14. Moreover, the closure bend 104 and the corresponding cover opening 105 are designed such that, when the cover 103 and the intermediate part are moved toward each other in longitudinal direction 4 each closure bend 104 is led through the corresponding cover opening 105 and latches into the cover 103 to form the form closure. Thus, the intermediate part 101 and the cover 103 are connected to each other by simply leading each closure bend 104 through the corresponding cover opening 105.

As indicated in FIG. 8, the heating device 1 is preferably manufactured by leading each heating module 3 through the corresponding passage opening 15 in the bottom 14 into the control volume 13, such that a longitudinal front face 36 of the respective heating module 3 is arranged in the control volume 13 of the latter housing 9. Additionally, the intermediate part 101 is preassembled on the cover 103. The cover 103 together with the preassembled intermediate part 101 is arranged on the bottom 14 such that each outer shell 7 is led through the corresponding arrangement opening 102. This is achieved by moving the cover 103 together with the preassembled intermediate part 101 in vertical direction 30 towards the bottom 14. Then the intermediate part 101 and the cover 103 are fastened to the bottom 14.

In the exemplary embodiments shown, the intermediate part 101 and the cover 103 are fattened to the bottom 14 by means of common screws 111 (see for instance FIGS. 3 to 6). To this end, in the exemplary embodiments shown, the intermediate part 101 and the cover 103 comprise corresponding openings 110 for each screw 111. The openings 110 are also referred to as fastening openings 110 in the following. A common screw 111 is thereby led through the corresponding fastening openings 110 and screwed into the bottom 14, such that a screw head 112 of the screw 111 rests on the cover 103 and presses the cover 103 and the intermediate part 101 towards the bottom 14 (see in particular FIGS. 5 and 6). In the exemplary embodiments shown, by way of example, three such screws 111 fasten the intermediate part 101 and the cover 103 to the bottom 14. Thus the intermediate part 101 and the cover 103 comprises three pairs of corresponding fastening openings 110. As in particular shown in FIG. 6, in the exemplary embodiments shown, the bottom 14, for at least one screw 111 comprises a corresponding collar 113. In the exemplary embodiments shown, the bottom 14 for each screw 111 comprises a corresponding collar 113. In FIG. 6, for the sake of better overview, only the outer shell 7 of the visible heating module 3 is shown. Each collar 113 projects towards the intermediate part 101. Each screw 111 is arranged in the corresponding collar 113. In the exemplary embodiments shown each collar 113 comprises an internal thread 116 in which the corresponding screw 111 is screwed (see FIG. 6). As can be seen for example in FIG. 3, the intermediate part 101, for each collar 113 comprises a corresponding collar opening 114, thorough which the corresponding collar 113 is led. The respective collar opening 114 results in a screw bend 115 which is formed to project towards the cover 103 and comprises the fastening opening 110 corresponding to the corresponding screw 111. Each screw bend 115 thereby rests on the side of the collar 113 facing away from the bottom 14 and thus facing the cover 103. The screw bend 115 is thus clamped between the collar 113 and the cover 103 by means of the corresponding screw 111. This leads to an increased an improved conductive contact of the intermediate part 101 with the bottom 14.

As shown in FIG. 6, in the exemplary embodiments shown, the cover 103, on the side facing the intermediate part 101, comprises at least one projecting bump 109 which presses the intermediate part 101 towards the bottom 14. This leads to an increased and more stable conductive contact of the intermediate part 101 with the bottom 14. As shown in FIG. 6, in the exemplary embodiments shown, the cover 103, on each transverse side of each arrangement opening 102 comprises at least one such bump 109.

As for instance shown in FIGS. 3 and 8, the plugs 35 of each heating module 3 project from the corresponding vertical front face 36 of the heating module 3. In the exemplary embodiments shown, the cover 103 covers each front face 36 and, for each plug 35 comprises a corresponding plug opening 117, through which the corresponding plug 35 is led.

In the exemplary embodiments shown, the electric contact of the intermediate part 101 with the respective outer shell 7 is achieved by spring elements 118 of the intermediate part 101. For this purpose, in the exemplary embodiments shown, the intermediate part 101, for each outer shell 7 comprises corresponding spring elements 118 which protrude from the corresponding arrangement opening 102 and rest on the corresponding outer shell 7 and are mechanically loaded against the outer shell 7. Each of the spring elements 118 is preferably coated with a friction-resistant and conductive material, in particular with silver, on its side facing the corresponding outer shell 7. In the exemplary embodiments shown, the spring elements 118 each rest on a corresponding outer wall 29 of the corresponding outer shell 7, such that each outer wall 29 is in contact with at least one spring element 118. In the exemplary embodiments shown, each outer wall 29 is in contact with two or three spring elements 118. In the exemplary embodiments shown, the cover 103, for each spring element 118 comprises a corresponding bump 109, as can be seen in FIGS. 6 and 7.

In the exemplary embodiments shown, the intermediate part 101 is a one-piece and monolithic part, preferably a one-piece sheet metal part. In the exemplary embodiments shown, the cover 103 is a one piece-part and monolithic part. In the exemplary embodiments shown, the cover 103 is an injection-mold part. The cover 103 might be electrically insulating.

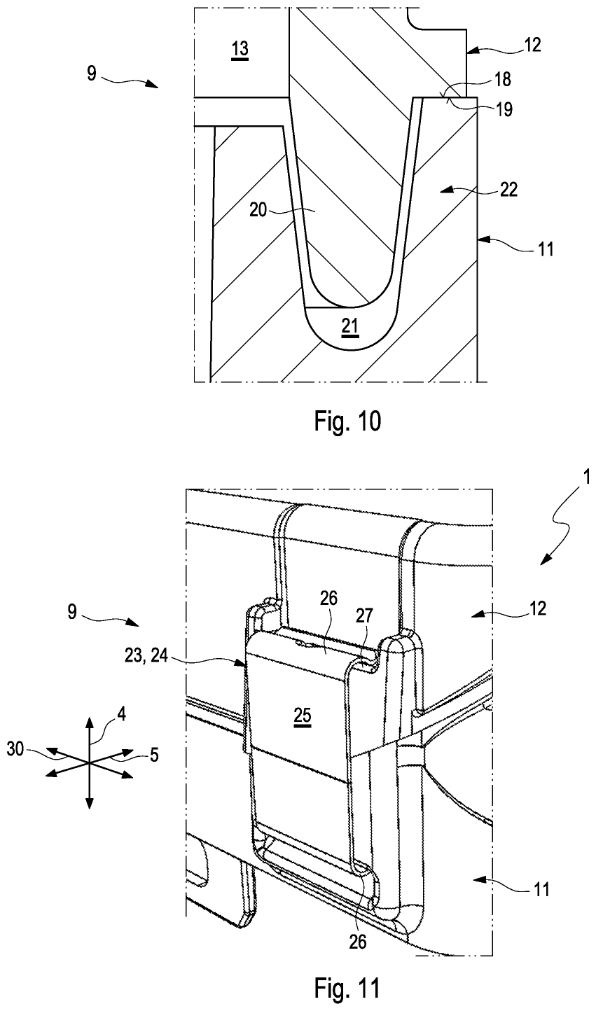

As can be seen for example from FIGS. 1, 9 and 11, the housing parts 11, 12 are electrically connected to one another. For this purpose, the respective housing part 11, 12 has an associated support surface 18, 19, the support surfaces 18, 19 resting on one another. That is, the first housing part 11 has a support surface 18 and the second housing part 12 has a support surface 19. The support surface 19 of the second housing part 12 is also referred to hereinafter as the counter-support surface 19 for better differentiation. As can be seen in particular from FIG. 10, the support surface 18 rests on the counter-support surface 19. This results in an electrical connection between the housing parts 11, 12. As can be seen, for example, from FIGS. 1 and 10, the support surface 18 and the counter-support surface 19 of the exemplary embodiments shown are each on the outside and circumferentially transverse to the longitudinal direction 4. Support surface 18 and counter-support surface 19 are thereby arranged outside the control volume 13 transversely to the longitudinal direction 4 and extend circumferentially.

As can be seen from FIG. 10, in the exemplary embodiments shown, one of the housing parts 11, 12 has a shoulder 20 projecting in the longitudinal direction 4 and the other housing part 11, 12 has an associated receptacle 21, which engage in one another in the manner of a tongue-and-groove connection 22. In the exemplary embodiments shown, the first housing part 11 has the receptacle 21 and the second housing part 12 has the shoulder 20. The shoulder 20 and the receptacle 21 are circumferential. As can further be seen from FIG. 10, the shoulder 20 and the receptacle 21 are arranged on the side of the support surface 18 and the counter-support surface 19 facing the control volume 13. As can also be seen from FIG. 10, the receptacle 21 is not completely filled with the shoulder 20. The receptacle 21 is filled, in particular before insertion of the shoulder 20, with an adhesive sealing compound, for example a silicone compound, which is not shown. This seals the control volume 13 from the outside.

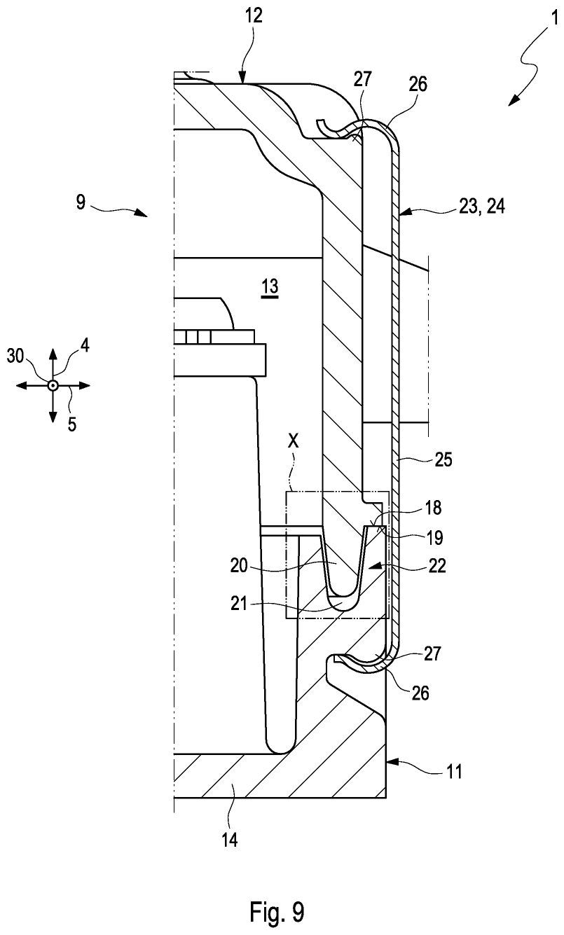

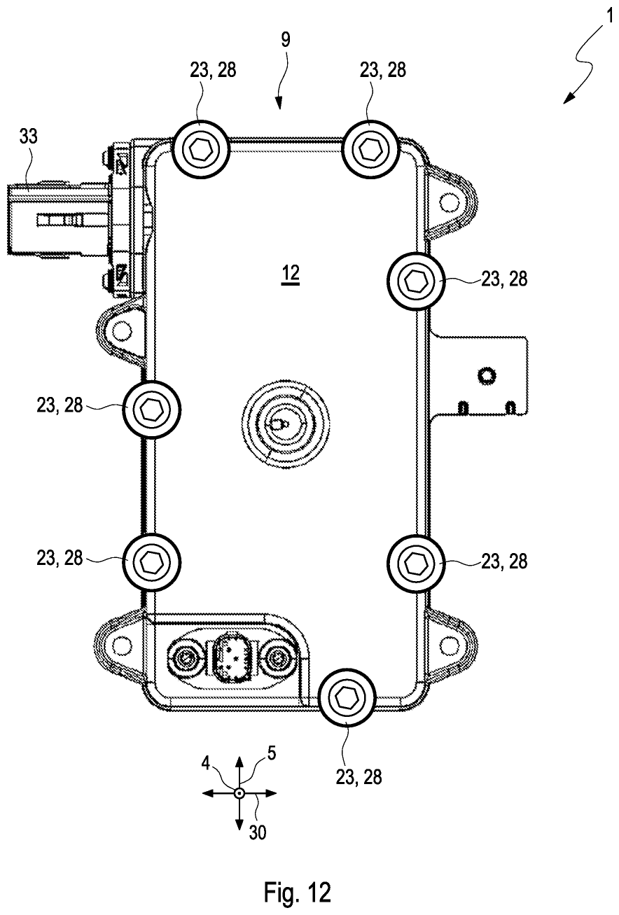

According to FIGS. 1 and 9 and 10, a further electrical connection of the housing parts 11, 12 in the exemplary embodiments shown is made by a mechanical connection 23 of the housing parts 11, 12 to one another. As can be seen from FIGS. 1 and 12, two or more such connections 23 are provided, which are arranged circumferentially spaced apart from one another. In the embodiments of FIGS. 1 to 11, the respective connection 23 is formed by an electrically conductive spring closure 24. The spring closure 24 has a spring base 25, from each end of which a spring bend 26 is bent over, one of the bends 26 engaging in the first housing part 11 and the other bend 26 engaging in the second housing part 12. Thus, the housing parts 11, 12 are mechanically loaded against each other along the spring closure 24. As can be seen, for example, from FIG. 9, the respective housing part 11, 12 has a bead 27 for the respective associated spring bend 26, so that the spring bends 26 are secured to the respective associated housing part 11, 12. As can also be seen from FIG. 9, the respective spring base 25 of the exemplary embodiments shown extends in the longitudinal direction 4.

In the exemplary embodiment of FIGS. 1 to 9, the respective spring bend 26 associated with the second housing part 12 engages externally in the second housing part 12 in the longitudinal direction 4. The embodiment example shown in FIG. 11 differs from this in that the spring bends 26 associated with the second housing part 12 engage in the second housing part 12 offset in the longitudinal direction 4 towards the first housing part 1.

The exemplary embodiment shown in FIG. 12 differs from the exemplary embodiments shown in FIGS. 1 to 8 in that the respective connection 23 is formed by an indicated housing screw connection 28.

As can be seen for example in FIGS. 1 and 3, the heating device 1 of the exemplary embodiments shown has an undulating corrugated rib 16 on the outer wall 29 of the respective outer shell 7 through which fluid can flow. Thus, a corrugated rib 16 is arranged between each of the facing outer walls 29 of the heating modules 3. In addition, in the exemplary embodiments shown, a corrugated rib 16 is also arranged in each case on the outermost outer walls 29 in the transverse direction 5. The respective corrugated rib 16 is connected to the at least one associated outer wall 29 in a heat-transferring manner. Preferably, the respective corrugated rib 16 is electrically conductive and mechanically connected to the respective associated outer wall 29. Thus, the respective corrugated rib 16 is also connected at the same electrical potential as the outer shells 7 and the control housing 9 and thus at equipotential.

The equipotential connection of the outer shells 7, the housing parts 11, 12 and, as the case may be, the corrugated ribs 16, makes it possible to detect undesirable electrical currents and leaks within the heating device 1 easily and reliably, for example by connecting them to the electrical ground 32. Thus, the operational safety is increased. In addition, a disturbance of the power electronics is reduced. Furthermore, arranging the conductor arrangement 100 inside the control volume 13 avoids a flow resistance for fluid caused by the conductor arrangement 100.

1. An electric heating device, comprising:
a heating volume through which a flow path of a fluid extends;
at least two heating modules arranged in the heating volume, the at least two heating modules extending in a longitudinal direction and disposed spaced apart from one another in a transverse direction extending transversely to the longitudinal direction;
the at least two heating modules each including at least one electrical heating element which generates heat when electrically supplied such that the respective heating module heats the fluid;
the at least two heating modules each further including an electrically conductive outer shell;
an electrically conductive control housing delimiting a control volume;
a power electronics for electrically supplying the at least two heating modules, the power electronics arranged in the control volume;
the control housing having a bottom which delimits the heating volume;
the bottom including a plurality of passage openings for the at least two heating modules, each of the at least two heating modules extending through an associated passage opening of the plurality of passage openings into the control volume in the longitudinal direction;
the at least two heating modules, in the control volume, electrically connected to the power electronics;
an electrically conductive conductor arrangement electrically connecting the outer shell of each of the at least two heating modules to the control housing;
the conductor arrangement including an intermediate part resting against the bottom and electrically connected to the bottom and to the outer shells of each of the at least two heating modules;
the intermediate part including a plurality of arrangement openings, the outer shell of each of the at least two heating modules extending through an associated arrangement opening of the plurality of arrangement openings in the longitudinal direction;
the conductor arrangement further including, on a side of the intermediate part averted from the bottom, a cover covering the intermediate part;
the intermediate part further including at least one closure bend projecting in a direction of the cover;
the cover including at least one cover opening for the at least one closure bend; and
wherein the at least one closure bend extends through the at least one cover opening and engages with the cover to form a form closure.

2. The heating device according to claim 1, wherein:
the at least one closure bend includes a lower section on a side facing the bottom and an upper section connected to the lower section and extending inclined to the lower section towards the bottom such that the at least one closure bend is in the manner of a spring clip; and
the at least one closure bend and the at least one cover opening are configured such that, when the cover and the intermediate part are moved toward each other in the longitudinal direction, the at least one closure bend extends through the at least one cover opening and latches into the at least one cover opening.

3. The heating device according to claim 1, wherein the cover further includes, on a side facing the intermediate part, at least one projecting bump which presses the intermediate part towards the bottom.

4. The heating device according to claim 1, wherein:
the intermediate part and the cover each further include a fastening opening of a pair of corresponding fastening openings; and
a common screw extends through the pair of corresponding fastening openings and is screwed into the bottom such that a screw head of the screw rests on the cover and presses the cover and the intermediate part towards the bottom.

5. The heating device according the claim 4, wherein:
the bottom further includes a collar projecting towards the intermediate part;
the common screw is arranged in the collar;
the intermediate part further including a collar opening, thorough which the collar extends;
the intermediate part further includes a screw bend projecting towards the cover, the screw bend including the fastening opening of the intermediate part; and
the screw bend rests on a side of the collar facing away from the bottom.

6. The heating device according to claim 5, wherein the collar includes an internal thread in which the common screw is screwed.

7. The heating device according to claim 1, wherein the intermediate part and the cover are arranged inside the control volume.

8. The heating device according to claim 7, wherein:
each of the at least two heating module further includes a longitudinal front face and at least one electric plug projecting from the longitudinal front face and connected to the power electronics;
the cover covers the longitudinal front face of each of the at least two heating modules; and
the cover further includes a plurality of plug openings, the at least one plug of each of the at least two heating modules extending through a corresponding plug opening of the plurality of plug openings.

9. The heating device according to claim 1, wherein the intermediate part further includes a plurality of spring elements which each (i) protrude from an associated arrangement opening of the plurality of arrangement openings and (ii) rest on and are mechanically loaded against the outer shell of an associated heating module of the at least two heating modules.

10. The heating device according to claim 9, wherein at least one of the plurality of spring elements is coated with a friction-resistant and conductive material on a side facing the outer shell of the associated heating module.

11. The heating device according to claim 1, wherein at least one of the intermediate part and the cover is structured as a one piece part.

12. The heating device according to claim 1, wherein at least one of the intermediate part and the cover is a sheet metal part.

13. The heating device according to claim 1, wherein the cover is electrically insulating.

14. A method for manufacturing the heating device of claim 1, comprising:
leading the at least two heating modules through the bottom;
preassembling the intermediate part on the cover; and
arranging the cover together with the intermediate part on the bottom and fastening the cover and the intermediate part to the bottom, such that the outer shell of each of the at least two heating modules extends through the associated arrangement opening.

15. A motor vehicle, comprising a heating device according to claim 1 and an electrical ground, wherein the control housing is electrically connected to the electrical ground.

16. The heating device according to claim 1, wherein the outer shell of at least one of the at least two heating modules is structured as an electrically conductive flat tube.

17. The heating device according to claim 1, wherein:
the at least one closure bend includes a plurality of closure bends;
the at least one cover opening includes a plurality of cover openings; and
the plurality of closure bends each extend through an associated cover opening of the plurality of cover openings and engage the cover such that the intermediate part and the cover are connected to one another and define the form closure.

18. The heating device according to claim 1, wherein:
the control housing includes a first housing part, a second housing part, and a plurality of electrically conductive spring closures that electrically and mechanically connect the first housing part and the second housing part to each other; and
the first housing part includes the bottom.

19. The heating device according to claim 9, wherein at least one of the plurality of spring elements is at least partially coated with silver.

20. The heating device according to claim 9, wherein the plurality of spring elements includes:
a first subset of spring elements that each contact the outer shell of a first heating module of the at least two heating modules; and
a second subset of spring elements that each contact the outer shell of a second heating module of the at least two heating modules.
